(19) United States
(12) Patent Application Publication
(10) Pub. No.: US 2011/0026054 A1
(43) Pub. Date: Feb. 3, 2011

(54) METHOD FOR PRINTING ELECTRONIC BOOK VIA ELECTRONIC BOOK READER

(75) Inventor: WEI-TIAN WENG, Shenzhen City (CN)

Correspondence Address: Altis Law Group, Inc.;ATTN: Steven Reiss, 288 SOUTH MAYO AVENUE, CITY OF INDUSTRY, CA, 91789, US

(73) Assignees: HONG FU JIN PRECISION INDUSTRY (ShenZhen) CO., Ltd., ShenZhen City (CN); HON HAI PRECISION INDUSTRY CO., LTD., Tu-Cheng (TW)

(21) Appl. No.: 12/608,988

(22) Filed: Oct. 29, 2009

(30) Foreign Application Priority Data
Jul. 30, 2009 (CN) 200910304976.7

(51) Int. Cl. G06K 1/00; G06F 3/12

(52) U.S. Cl. 358/1.9; 358/1.15

(57) ABSTRACT

A method is used to print an electronic book via an electronic book reader which stores a note file related to the electronic book. The method includes following steps. Firstly, a printing module of the electronic book reader sets printing parameters for printing the electronic book. Then, check whether the parameter comprises a choice of printing note. If the parameter comprises the choice of printing note, integrate the note file in the electronic book. The electronic book reader transmits the electronic book and the printing parameters to a printer. The printer prints the electronic book according to the printing parameters.

### BACKGROUND

1. Technical Field

The present disclosure relates to a printing method, and particularly to a method for printing electronic books via an electronic book reader.

2. Description of Related Art

An electronic book is an e-text that forms the digital media equivalent of a conventional printed book. Electronic books are usually read on personal computers or smart phones, or on dedicated hardware devices known as electronic book readers. An electronic book reader is capable of containing a plurality of electronic books therein. It is easier to carry around then the same books in printed form.

Users often desire to write notes in the margins in a book when they read, which is easily done with printed books. When reading electronic books however, notes are added using a word processing function of the electronic book reader. Unfortunately, electronic book readers are not usually equipped with a printing function. If a user needs to print an electronic book and the notes related to the electronic book, the electronic book along with the notes are first transmitted to a computer, and then the electronic book and the notes may be printed via the computer, which is inconvenient.

Therefore, there is room for improvement within the art.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a block view of an electronic book reader.

FIG. 2 is a block view of a printing module of the electronic book reader of FIG. 1 connected to a printer.

FIG. 3 is a flow chart of printing an electronic book via an electronic book reader.

FIG. 4 is a flow chart of detailed steps of the step S305 of FIG. 3.

### DETAILED DESCRIPTION

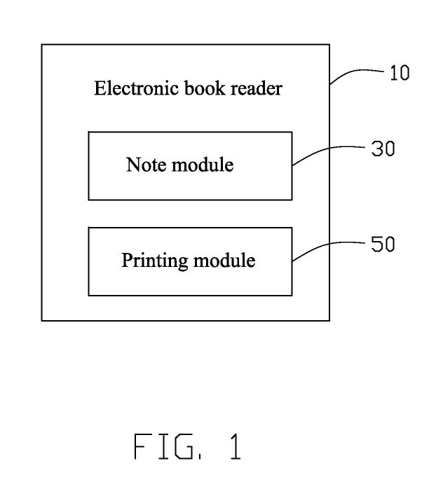

Referring to FIG. 1, an electronic book reader 10, in accordance with an embodiment of the present disclosure, includes a note module 30 and a printing module 50. The note module 30 is capable of generating corresponding note files when users make notes on the electronic book reader 10.

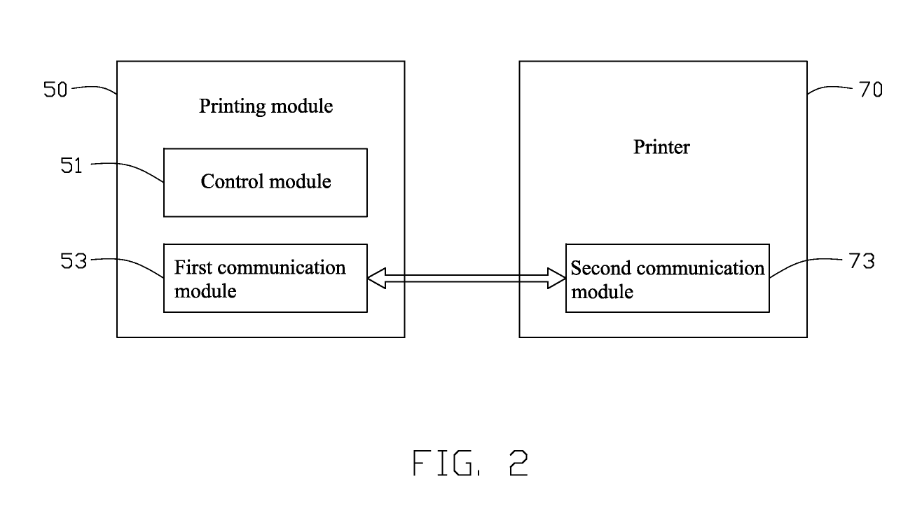

Referring to FIG. 2, the printing module 50 includes a control module 51 and a first communication module 53. The first communication module 53 is connected to a second communication module 73 of a printer 70 for transmitting files from the electronic book reader 10 to the printer 70. Communication between the first communication module 53 and the second communication module 73 can be accomplished in different ways, such as using a WIFI (wireless fidelity) connection, and so on.

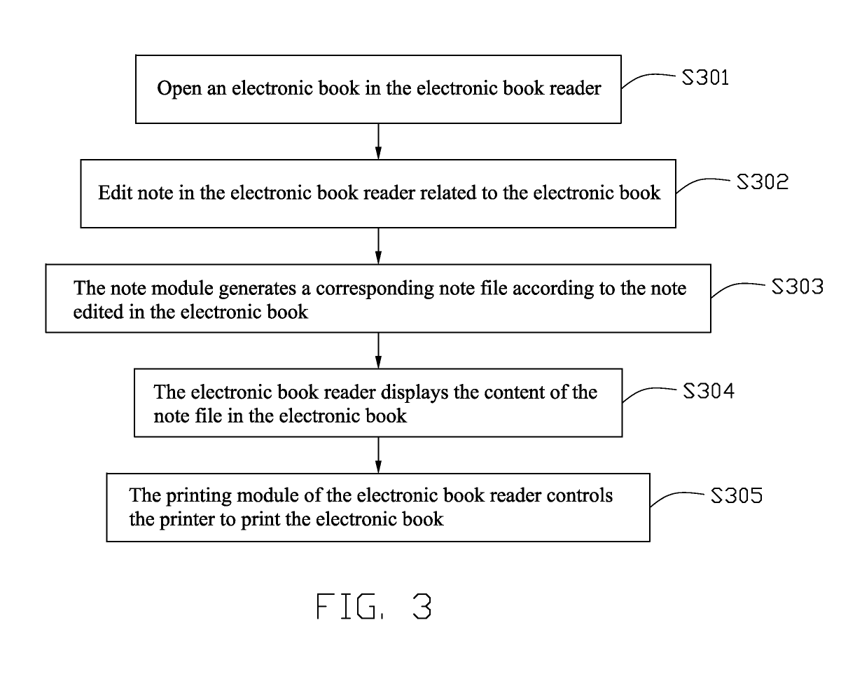

Referring to FIG. 3, a flow chart of printing electronic books via the electronic book reader 10 is shown:

In step S301, open an electronic book in the electronic book reader 10; then go to step S302.

In step S302, edit notes in the electronic book reader 10 related to the electronic book, such as adding annotations, highlights, or bookmarks in the electronic book; then go to step S303.

In step S303, the note module 30 generates a corresponding note file according to the notes edited in the electronic book, the note file includes information of content of the note file, a position of the content of the note file in the electronic book, and so on; then go to step S304.

In step S304, the electronic book reader 10 displays the content of the note file in the electronic book; then go to step S305.

In step S305, the printing module 50 of the electronic book reader 10 controls the printer 70 to print the electronic book and the notes.

In the above flow, steps S303 and S304 are processed very quickly, so after the user enters notes in the electronic book, the content of the note file is displayed on the electronic book reader 10 immediately.

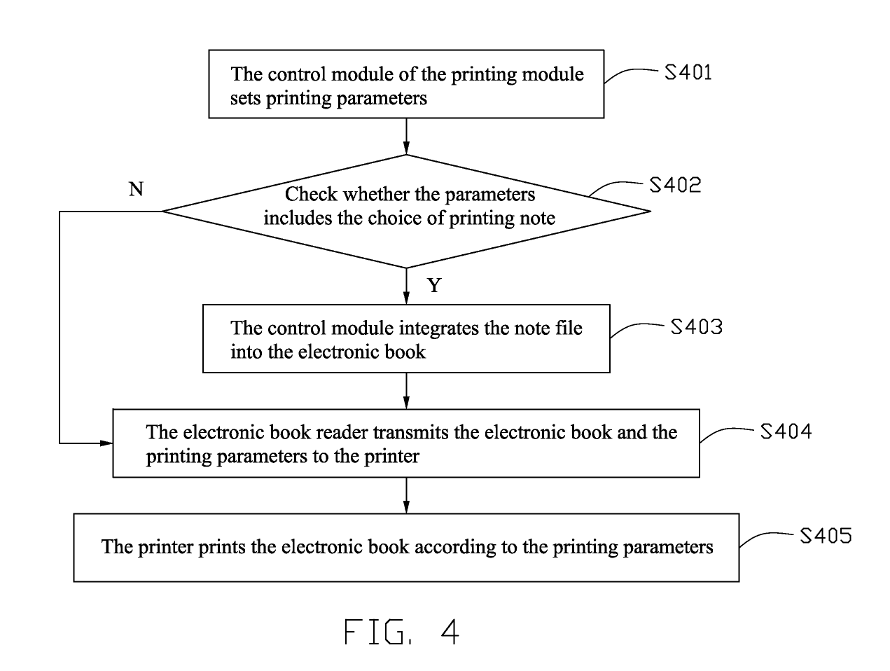

Referring to FIG. 4, detailed steps of the step S305 are shown:

In step S401, the control module 51 of the printing module 50 sets printing parameters which includes choices of print range, print copies, printing note, and so on; then go to step S402.

In step S402, check whether the parameters includes the choice of printing notes; if it printing of notes is chosen, go to step 403; otherwise, go to step S404.

In step S403, the control module 51 integrates the note file into the electronic book; then go to step S404.

In step S404, the electronic book reader 10 transmits the electronic book and the printing parameters to the printer 70 via the first communication module 53 and the second communication module 73; then go to step S405.

In step S405, the printer 70 prints the electronic book according to the printing parameters.

It is to be understood, however, that even though numerous characteristics and advantages of the embodiments have been set forth in the foregoing description, together with details of the structure and function of the embodiments, the disclosure is illustrative only, and changes may be made in detail, especially in matters of shape, size, and arrangement of parts within the principles of the present disclosure to the full extent indicated by the broad general meaning of the terms in which the appended claims are expressed.

It is also to be understood that the above description and the claims drawn to a method may include some indication in reference to certain steps. However, the indication used is only to be viewed for identification purposes and not as a suggestion as to an order for the steps.

What is claimed is:

1. A method for printing an electronic book via an electronic book reader, the electronic book reader storing a note file related to the electronic book, the method comprising following steps:
a printing module of the electronic book reader setting printing parameters for printing the electronic book;
checking whether the parameter comprises a choice of printing note;
if the parameter comprises the choice of printing note, integrating the note file in the electronic book;
the electronic book reader transmitting the electronic book and the printing parameters to a printer; and
the printer printing the electronic book according to the printing parameters.

2. The method of claim 1, wherein if the parameter does not comprise the choice of printing note, the electronic book reader transmits the electronic book and the printing parameters to the printer directly.

3. The method of claim 1, wherein the printing parameters further comprises choices of print range and print copies.

4. The method of claim 1, wherein the note file comprises information of content of the note file, and a position of the content of the note file in the electronic book.

5. The method of claim 4, wherein the content of the note file comprises annotations, highlights, or bookmarks.

6. The method of claim 1, wherein the electronic book reader comprises a first communication module via which the electronic book and the printing parameters are transmitted to a printer.

7. The method of claim 6, wherein the printer comprises a second communication module communicating with the first communication module.

8. A method for printing an electronic book via an electronic book reader, the electronic book reader comprising a note module, the method comprising following steps:
opening the electronic book in the electronic book reader;
editing notes in the electronic book reader related to the electronic book, and the note module generating a corresponding note file;
integrating the note file in the electronic book; and
the electronic book reader transmitting the electronic book to a printer for printing the electronic book.

9. The method of claim 8, wherein before the electronic book reader transmits the electronic book to the printer, a printing module of the electronic book reader sets printing parameters for printing the electronic book.

10. The method of claim 9, wherein the printing parameters comprises choices of print range and print copies.

11. The method of claim 10, wherein the note file comprises information of content of the note file, and a position of the content of the note file in the electronic book.

12. The method of claim 11, wherein the content of the note file comprises annotations, highlights, or bookmarks.

13. The method of claim 8, wherein the electronic book reader comprises a first communication module via which the electronic book are transmitted to a printer.

14. The method of claim 13, wherein the printer comprises a second communication module communicating with the first communication module.
